(19) United States
(12) Patent Application Publication
(10) Pub. No.: US 2007/0005723 A1
(43) Pub. Date: Jan. 4, 2007

(54) Communication apparatus and communication method

(75) Inventor: Hirotsugu Kato, Konosu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/477,563

(22) Filed: Jun. 30, 2006

(30) Foreign Application Priority Data
Jun. 30, 2005 (JP) 2005-193149

(51) Int. Cl. G06F 15/16

(52) U.S. Cl. 709/217

(57) ABSTRACT

According to one embodiment, there is provided a communication apparatus comprising a communication unit which makes a communication via a network, a clock unit, and a processing unit which generates an HTTP header including time information from the clock unit, generates HTTP data including address information of a server device that manages a content, and a command to process the content, and supplies the HTTP header and the HTTP data to an external device on the network via the communication unit.

### CROSS-REFERENCE TO RELATED APPLICATIONS

This application is based upon and claims the benefit of priority from Japanese Patent Application No. 2005-193149, filed Jun. 30, 2005, the entire contents of which are incorporated herein by reference.

### BACKGROUND

1. Field

One embodiment of the invention relates to communication apparatuses between networks, and in particular, to communication apparatuses and a communication method for acquiring contents from a server device on the Internet to process the contents.

Recently, the network technology has been remarkably popularized, and apparatuses for carrying out authentication processing and determination processing among a plurality of communication apparatuses have been known.

2. Description of the Related Art

In Patent Document 1 (Jpn. Pat. Appln. KOKAI Publication No. 2003-208406), there is disclosed a system which prevents misrepresentation of a service providing time by transmitting time information between a service providing device and an authentication device. Namely, at the time of off-line service providing for a designated period, it is possible to prevent unauthorized use of a service providing device due to misrepresentation of a setting time in the system disclosed in the above publication.

In the system in Patent Document 1, however, there is the problem that, when an attempt is made to cause a communication apparatus serving as an opponent party, which does not have an independent clock function, to acquire a content on a web server on, for example, the Internet and print the content, it is not obvious how to collect time information or how to give a (print) command.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of a configuration of communication apparatuses according to one embodiment of the present invention;

FIG. 2 is a block diagram showing one example of a detailed configuration of the communication apparatuses according to the embodiment of the present invention;

FIG. 3 is a flowchart showing one example of requesting processing of a communication apparatus (host device) according to the embodiment of the present invention;

FIG. 4 is a flowchart showing one example of URL print processing of a communication apparatus (print device) according to the embodiment of the present invention; and

FIG. 5 is a system chart showing one example of LAN formed by communication apparatuses according to one embodiment of the present invention.

### DETAILED DESCRIPTION

Various embodiments according to the invention will be described hereinafter with reference to the accompanying drawings. In general, according to one embodiment of the invention, there is provided communication apparatuses in which, among a plurality of communication apparatuses on a network such as LAN, a communication apparatus having a clock function can cause a communication apparatus having no clock function to acquire a content on a web server on the Internet, and process the content.

One embodiment of the invention is a communication apparatus comprising: a communication unit which makes a communication via a network; a clock unit; and a processing unit which generates an HTTP header including time information from the clock unit, generates HTTP data including address information of a server device that manages a content, and a command to process the content, and supplies the HTTP header and the HTTP data to an external device on the network via the communication unit.

In the communication apparatus described above, a communication apparatus having a clock function can cause a communication apparatus having no clock function to acquire a content on a web server on the Internet and process the content.

Hereinafter, the embodiment of the present invention will be described in detail with reference to the drawings.

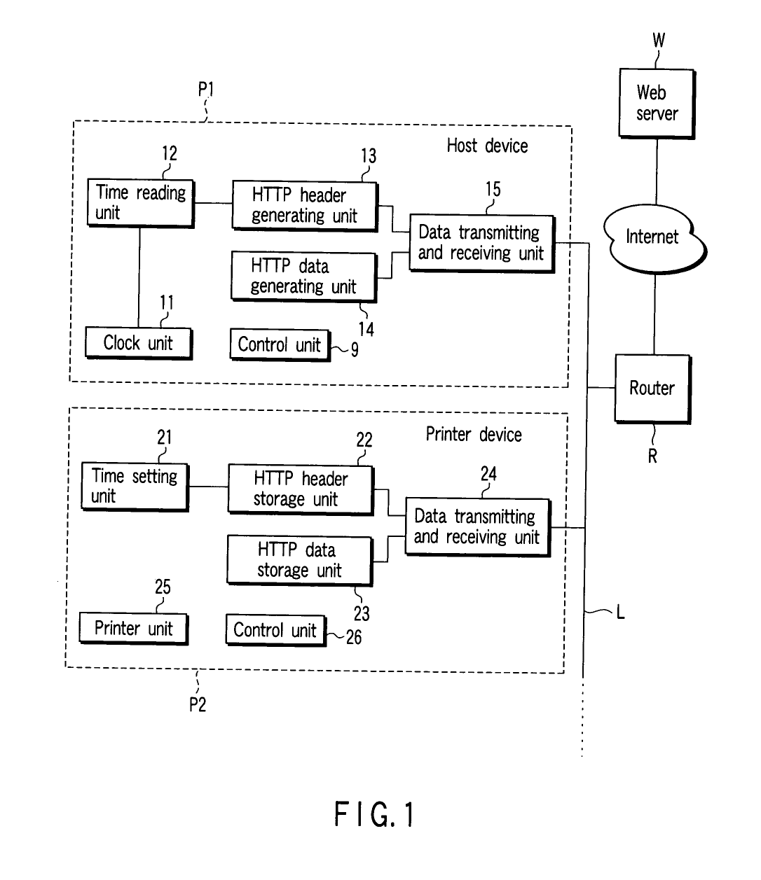

FIG. 1 is a block diagram showing one example of a configuration of communication apparatuses according to one embodiment of the present invention.

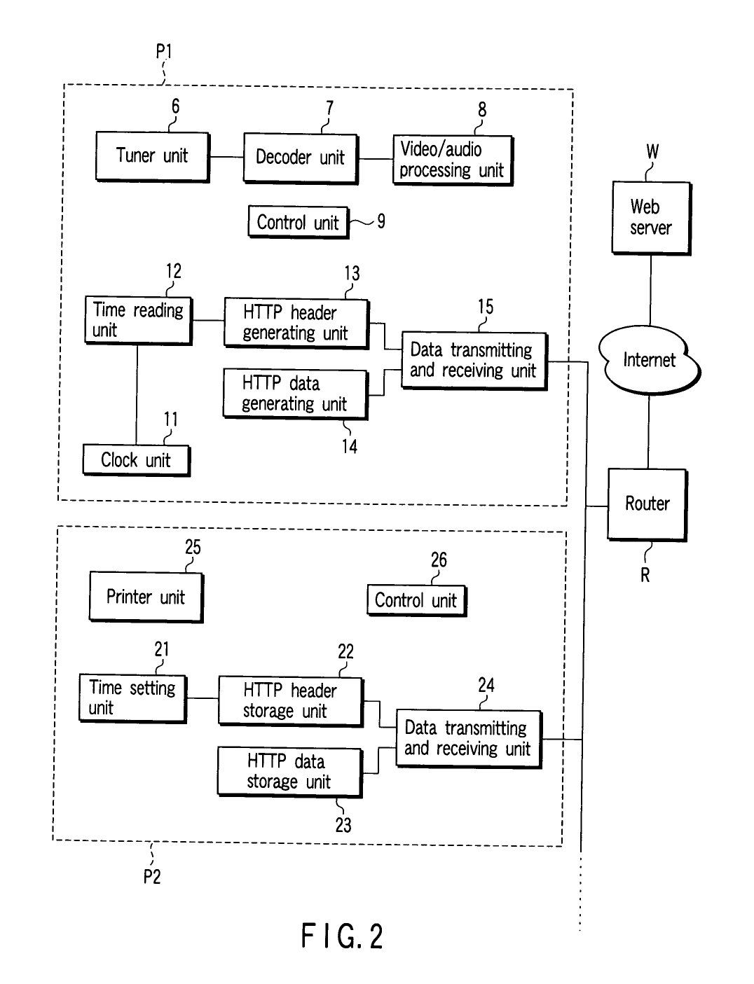

FIG. 2 is a block diagram showing one example of a detailed configuration of the communication apparatuses according to the embodiment of the present invention.

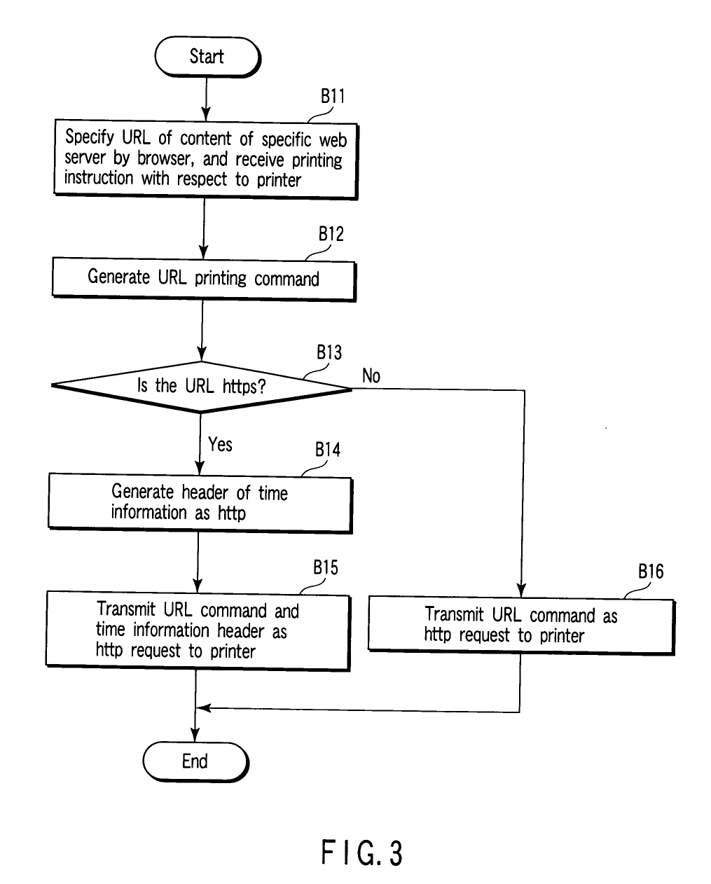

FIG. 3 is a flowchart showing one example of requesting processing of a communication apparatus (host device) according to the embodiment of the present invention.

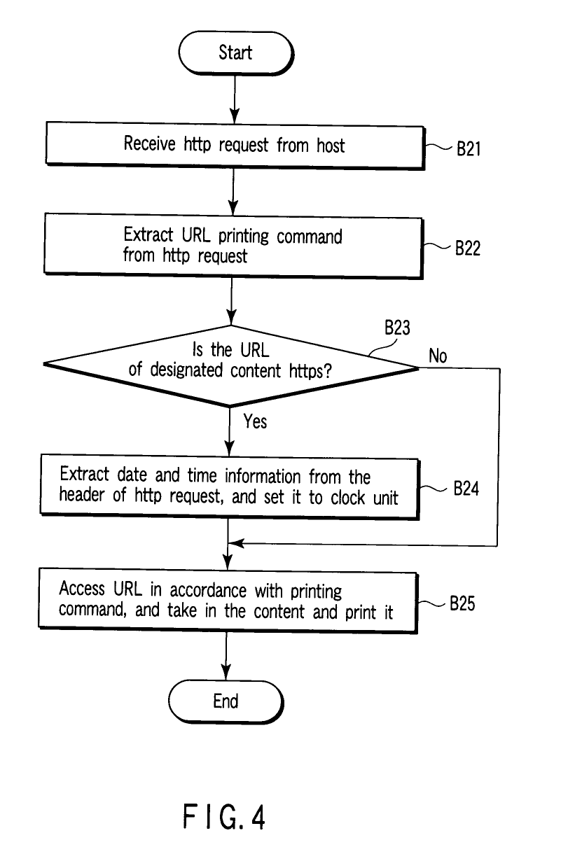

FIG. 4 is a flowchart showing one example of URL print processing of a communication apparatus (print device) according to the embodiment of the present invention.

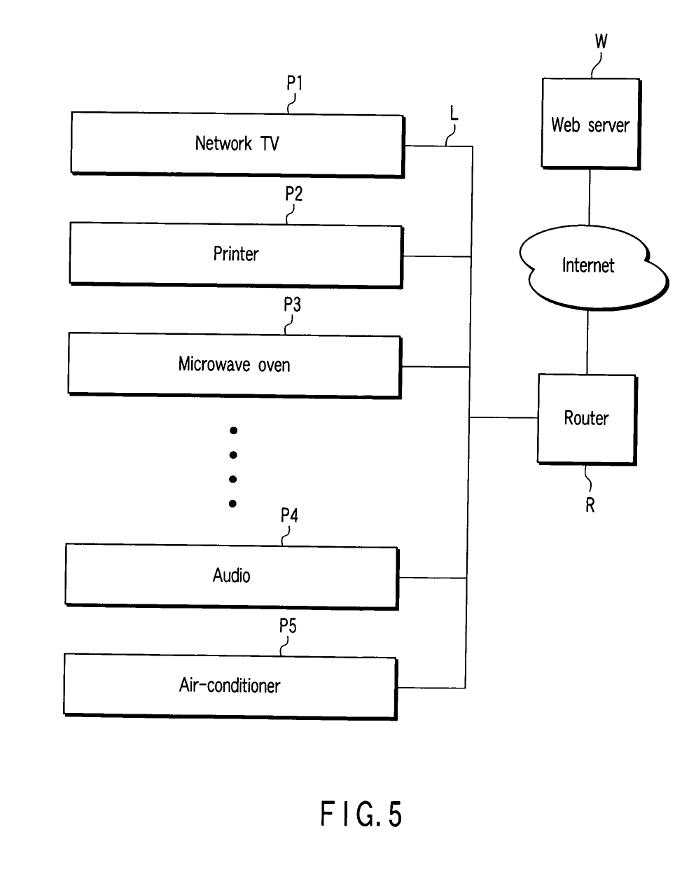

FIG. 5 is a system chart showing one example of LAN formed by communication apparatuses according to one embodiment of the present invention.

<Host Device and Printer Device>

Between the communication apparatuses (a host device and a printer device) according to one embodiment of the present invention, as one example, time information is supplied from a host device P1 having a clock function to a printer device P2 having no clock function. Accordingly, by merely giving “a command to acquire a desired content from a web server and to process (for example, print) it” from the host device P1 to the printer device P2, it is possible for the printer device P2 alone to carry out determination of server certificate data by using the time information, and an acquisition and (print) processing of a content.

Consequently, in the printer device P2, there is no need to provide a time device (clock) which retains and clocks time information, a backup power device of the time device for the time of power-off, a user interface for adjusting the time device, an NPT protocol for automatically adjusting the time device, a user interface for setting NPT protocol, and the like. Accordingly, there is no need for the host device P1 to take in a large-scale content or transfer it to the printer device, and further, there is no need to take a driver for the printer device or the like into consideration. Therefore, it is possible to provide an extremely easy processing system using a network.

(Configuration)

The communication apparatuses (the host device and the printer device) according to one embodiment of the present invention are, as shown in FIGS. 1 and 2, connected with one another via a network line L such as, for example, LAN (Local Area Network).

Here, in FIGS. 1 and 2, the host device P1 has: a clock unit 11 which automatically clocks current time information; a clock reading unit 12 which reads out the time information; an HTTP header generating unit 13 which generates an HTTP heater of the time information; an HTTP data generating unit 14 in which a URL of a content, a printing command, and the like are made to be transmitted HTTP entity data; a data transmitting and receiving unit 15 which transmits and receives HTTP data to and from an external device via a network; and a control unit 9 which controls the entire operations. Further, the host device P1 is, as one example, a network television device, and has a tuner unit 6, a decoder unit 7, and a video/audio processing unit 8 as shown in FIG. 2.

On the other hand, the printer device P2 (which is not limited to the printer device, and is preferably various application devices as will be described later in FIG. 5) has: a data transmitting and receiving unit 24 which acquires HTTP data or the like via LAN or the like; an HTTP header storage unit 22 which stores an HTTP header serving as time information; an HTTP data storage unit 23; a time setting unit 21 which sets a time on the basis of acquired time information; a printer unit 25 having a printer function; and a control unit 26 which controls the entire operations.

Moreover, a router R is connected to the network line L, and it is possible to make a communication with a web server device W on the Internet.

<Processing Operations>

Hereinafter, the communication processings between the host device P1 and the printer device P2 will be described in detail by using the flowcharts of FIGS. 3 and 4.

First, the communication processing operation of the host device P1 will be described by using FIG. 3.

As shown in the flowchart of FIG. 3, the host device P1 receives an operational instruction to specify a URL of a content of a specific web server device W on the Internet by a browser or the like, and to print the content by the printer device P2 on, for example, LAN in accordance with, for example, an user's operation (block B11). Accordingly, the HTTP data generating unit 14 generates transmitted HTTP entity data serving as printer control data on the basis of the print instructing command for the printer device P2 and the URL information showing location of a web server in which a content to be printed is stored, and inputs the transmitted HTTP entity data as a URL printing command to the data transmitting and receiving unit 15 (block B15).

Next, it is determined whether or not the URL of the web server device W which retains the content starts with https (whether it is secure communication or not) (block B13). When it is determined that the URL starts with https and it is secure communication (YES in block B13), the time information read out of the clock unit 11 via the time reading unit 12 is accordingly processed into an HTTP date header at the HTTP header generating unit 13, and moreover, another HTTP header is added thereto, so that the time information is inputted as a transmitted HTTP header to the data transmitting and receiving unit 15 (block B14). Note that a secure web server used herein means a server which provides a content in accordance with SSL/TLS protocol.

Then, the transmitted HTTP header and transmitted HTTP entity data are combined with each other, and the combined data is supplied as HTTP protocol printer control data to the printer device P2 via the network line L by means of the data transmitting and receiving unit 15 (block B15).

As one example of an HTTP request at this time, the following case can be conceived as an image of a ticket:

“Post_http://192.168.1.10/printer-control_HTTP/1.1

Date: Fri,_{—}25_Jun._{—}2005_{—}16:01:00_JST

(LF)

(URL printing command)
. . .
. . .

https://www.xxx.10.jp/chicket
. . .
. . . ”.

Further, when, in block B13, it is determined that the URL of the web server device W which retains the content does not start with https, and it is not secure communication (NO in block B13), it is possible to omit generation of a header of the time information of HTTP, and it is also possible immediately transmit the URL printing command as an HTTP request to the printer device P2 (block B16).

Next, the communication processing operation of the printer device P2 will be described by using FIG. 4.

The data transmitting and receiving unit 24 of the printer device P2 receives an HTTP request (HTTP protocol printer control data) from the host device P1 via the network line L (block B1). Then, the received HTTP header of the HTTP protocol printer control data and the received HTTP entity data are respectively supplied to the HTTP header storage unit 22 and the HTTP data storage unit 23. The HTTP data storage unit 23 extracts the URL printing command (received HTTP entity data) from the HTTP protocol printer control data (block B22).

Subsequently, in the same manner as in the above case, it is determined whether or not the URL of the web server which retains the content starts with https (whether it is secure communication or not) (block B23). Here, when it is determined that the URL starts with https, and it is secure communication (YES in block B23), the time information is accordingly extracted from the HTTP date header at the HTTP deader storage unit 22, and the extracted time information is inputted to the time setting unit 21, so that current time information is set to the system of the printer device P2 (block B24). When it is determined that the URL of the web server W which retains the content does not start with https, and it is not secure communication, there is no need to extract the time information from the HTTP Date header at the HTTP header storage unit 22 in block B24.

When it is determined that the URL of the web server W which retains the content starts with https (secure communication), the secure web server W has a server certificate for giving proof of the reliability itself, and a period of validity is described in the server certificate. When a client makes a request to the secure web server, the secure web server W transmits the server certificate to the client. In contrast thereto, the client verifies the period of validity of the server certificate, and determines whether or not the server certificate is within the period of validity at a current time. When it is no longer valid, the corresponding web server device W is determined to be an unreliable server, and the request is cancelled. When it is within the period of validity, a content is downloaded from the web server device W, and an image is formed onto a recording medium in the printer unit 25 under the control of the control unit 26 on the basis of the image information of the content (block B25).

As described above, when it is control for which time information is required is instructed from the host device P1, the printer device P2 can acquire time information from the HTTP Date header, and temporarily set a time. There is no need to always include a time device (clock) which retains and clocks time information, a backup power device of the time device for the time of power-off, a user interface for adjusting the time device, or an NPT protocol for automatically adjusting the time device, a user interface for setting NPT protocol, and the like.

<Other Communication Devices>

In the communication apparatuses according to the embodiment of the present invention, one embodiment relating to a printer has been described. However, the communication apparatuses according to the embodiment of the invention are not limited to a printer in the range of implementation thereof as long as they are controlled via a network and perform desired information processing.

In FIG. 5, an example of communication apparatuses having various functions is shown. Here, not only a network television P1 and the printer device P2 on the network L, but also, for example, a home electric device such as an electronic oven P3, an audio device P4, an air-conditioning device P5, and the like are suitable for use in the same purpose. Namely, among the recent network devices, it is beneficial to acquire various formed contents from a web server device W or the like on an external network such as the Internet. For example, it is effective for the electronic oven P3 to download specific recipe information to use, and further, it is effective for the audio device P4 to download music contents to use. Moreover, also with respect to home electric appliances of air-conditioning devices such as the air-conditioning device P5, an application in which a program for improving operational defects is downloaded or the like is available.

Accordingly, it is extremely of great significance, as the communication system of the present invention, to automatically access the Internet with ease to download necessary data by merely receiving an instruction command from a device having a host function such as a personal computer or a television even if a clock function is not provided.

More specifically, when control for which time information is required is instructed in a communication apparatus such as a printer device controlled by control data according to an HTTP protocol via a network, it is possible to acquire time information from the HTTP Date header included in the control data of the HTTP protocol supplied from the host device, and to temporarily set a time.

As a consequence, there is no need to always include a time device (clock) which retains and clocks time information, a backup power device of the time device for the time of power-off, a user interface for adjusting the time device, or an NPT protocol for automatically adjusting the time device, a user interface for setting NPT protocol, and the like. Accordingly, a system for network devices can be simply configured.

In the above-described embodiment, the communication protocol has been described by using HTTP. However, in the embodiment of the invention, the same operational effects can be brought about by the same processings according to not only this communication protocol, but also another communication protocol.

In accordance with the various embodiments described above, those skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a communication unit which makes a communication via a network;
a clock unit; and
a processing unit which generates an HTTP header including time information from the clock unit, generates HTTP data including address information of a server device that manages a content, and a command to process the content, and supplies the HTTP header and the HTTP data to an external device on a network via the communication unit.

2. The communication apparatus according to claim 1, wherein the processing unit supplies the time information from the clock unit to an external device on the network via the communication unit only when the address information of the server device starts with https.

3. The communication apparatus according to claim 1, further comprising:
a tuner unit which receives and demodulates a broadcast signal to output a video/audio signal; and
a video/audio processing unit which outputs the video/audio signal.

4. A communication apparatus comprising:
a communication unit which makes a communication via a network;
an execution unit which executes information processing on the basis of a content to be provided; and
a processing unit which, upon receipt of an HTTP header including time information, and HTTP data including address information of a server device that manages a content, and a command to process the content from a communication apparatus on the network via the communication unit, extracts the time information, the address information, and the processing command, accesses the server device on the Internet shown by the address information via the communication unit, receives server certificate data from the server device, and determines whether or not the server certificate data is within a period validity by using the time information; and when it is within the period of validity, acquires the content from the server device, and causes the execution unit to carry out information processing on the basis of the acquired content.

5. The communication apparatus according to claim 4, wherein the processing unit determines a period of validity of the server certificate data from the server device by using the time information only when the address information of the server device starts with https.

6. The communication apparatus according to claim 4, wherein the execution unit is a printer unit which forms an image onto a recording medium on the basis of image information of the content to be provided.

7. A communication method which is carried out between a first communication apparatus and a second communication apparatus provided on a network, the method comprising:
in the first communication apparatus, generating an HTTP header including the time information by clocking a current time, generating HTTP data including address information of a server device that manages a content and a command to process the content, and supplying the HTTP header and the HTTP data to the second communication apparatus on the network; and
in the second communication apparatus, upon receipt of the HTTP header and the HTTP data from the first communication apparatus, extracting the time information, the address information, and the processing command respectively from the HTTP header and the HTTP data, accessing the server device on the Internet shown by the address information, receiving server certificate data from the server device, and determining whether or not the server certificate data is within a period validity by using the time information; and when it is within the period of validity, acquiring the content from the server device, and carrying out information processing on the basis of the acquired content.

8. The communication method according to claim 7, wherein supply of the time information from the first communication apparatus to the second communication apparatus, and determination of a period of validity of the server certificate data based on the time information are carried out only when the address information of the server device starts with https.

9. The communication method according to claim 7, wherein the second communication apparatus has a printer function, and carries out image formation onto a recording medium on the basis of image information of the acquired content as the information processing.
